(19) United States
(12) Patent Application Publication
(10) Pub. No.: US 2017/0032788 A1
(43) Pub. Date: Feb. 2, 2017

(54) INFORMATION PROCESSING DEVICE

(71) Applicant: Sharp Kabushiki Kaisha, Sakai City, Osaka (JP)

(72) Inventors: Akira MOTOMURA, Sakai City (JP); Masanori OGINO, Sakai City (JP)

(21) Appl. No.: 15/303,583

(22) PCT Filed: Jan. 22, 2015
(86) PCT No.: PCT/JP2015/051703

§ 371 Date: Oct. 12, 2016

(30) Foreign Application Priority Data
Apr. 25, 2014 (JP) 2014-091919

(51) Int. Cl. G10L 15/22; G10L 13/02

(52) U.S. Cl. CPC G10L 15/22; G10L 13/02; G10L 2015/223

(57) ABSTRACT

In order to return an appropriate response even in a case where a plurality of utterances are successively made, provided are: a pattern identifying section (42) for, in a case where a target utterance with respect to which a phrase is to be determined as a response is accepted, identifying a handling status of another utterance which differs from the target utterance; and a phrase generating section (43) for determining, as a phrase responding to the target utterance, a phrase in accordance with the handling status identified by the pattern identifying section.

### TECHNICAL FIELD

The present invention relates to an information processing device and the like which determine a phrase in accordance with a voice which has been uttered by a speaker.

### BACKGROUND ART

There has conventionally and widely been studied an interactive system which allows a human to interact with a robot. For example, Patent Literature 1 discloses a technique in which a process to be carried out switches between (i) storage of input voice signals, (ii) analysis of an input voice signal, and (iii) analysis of the input voice signals thus stored, and in a case where the input voice signals are stored, voice recognition is carried out after an order of the input voice signals is changed.

### CITATION LIST

### Patent Literature

### [Patent Literature 1]

Japanese Patent Application Publication, Tokukaihei, No. 10-124087 (Publication date: May 15, 1998)

### [Patent Literature 2]

Japanese Patent Application Publication, Tokukai, No. 2006-106761 (Publication date: Apr. 20, 2006)

### [Patent Literature 3]

Japanese Patent Application Publication Tokukai, No. 2006-171719 (Publication date: Jun. 29, 2006)

### [Patent Literature 4]

Japanese Patent Application Publication Tokukai, No. 2007-79397 (Publication date: Mar. 29, 2007)

### SUMMARY OF INVENTION

### Technical Problem

Conventional techniques including those disclosed in Patent Literatures 1 through 4 are premised on a communication on a one-answer-to-one-question basis in which it is assumed that a speaker would wait for a robot to finish answering a question from the speaker. This causes a problem that in a case where the speaker successively makes a plurality of utterances, the robot may return an inappropriate response. Note that the problem is not limited to the robot but is caused by an information processing device in general which recognizes a voice uttered by a human and determines a response to the voice. The present invention has been accomplished in view of the problem, and an object of the present invention is to provide an information processing device and the like capable of returning an appropriate response even in a case where a plurality of utterances are successively made.

### Solution to Problem

In order to attain the object, an information processing device in accordance with an aspect of the present invention is an information processing device that determines a phrase responding to a voice which a user has uttered to the information processing device, including: a handling status identifying section for, in a case where a target utterance with respect to which a phrase is to be determined as a response is accepted, identifying a status of handling carried out by the information processing device with respect to another utterance which differs from the target utterance; and a phrase determining section for determining, as a phrase responding to the target utterance, a phrase in accordance with the handling status identified by the handling status identifying section.

### Advantageous Effects of Invention

An aspect of the present invention brings about an effect of being able to return an appropriate response even in a case where a plurality of utterances are successively made.

### BRIEF DESCRIPTION OF DRAWINGS

FIG. 1 is a function block diagram illustrating a configuration of an information processing device in accordance with Embodiment 1 of the present invention.

FIG. 2 is a flow chart showing a process in which the information processing device in accordance with Embodiment 1 of the present invention outputs a response to an utterance.

FIG. 3 is a view showing examples of a handling status of an utterance.

FIG. 4 is a flow chart showing in detail a process of selecting a template in accordance with an identified handling status pattern.

FIG. 5 is a function block diagram illustrating a configuration of an information processing device in accordance with Embodiment 2 of the present invention.

FIG. 6 is a flow chart showing a process in which the information processing device in accordance with Embodiment 2 of the present invention outputs a response to an utterance.

FIG. 7 is a block diagram illustrating a hardware configuration of an information processing device in accordance with Embodiment 3 of the present invention.

### DESCRIPTION OF EMBODIMENTS

### Embodiment 1

### 1. Overview of Information Processing Device 1

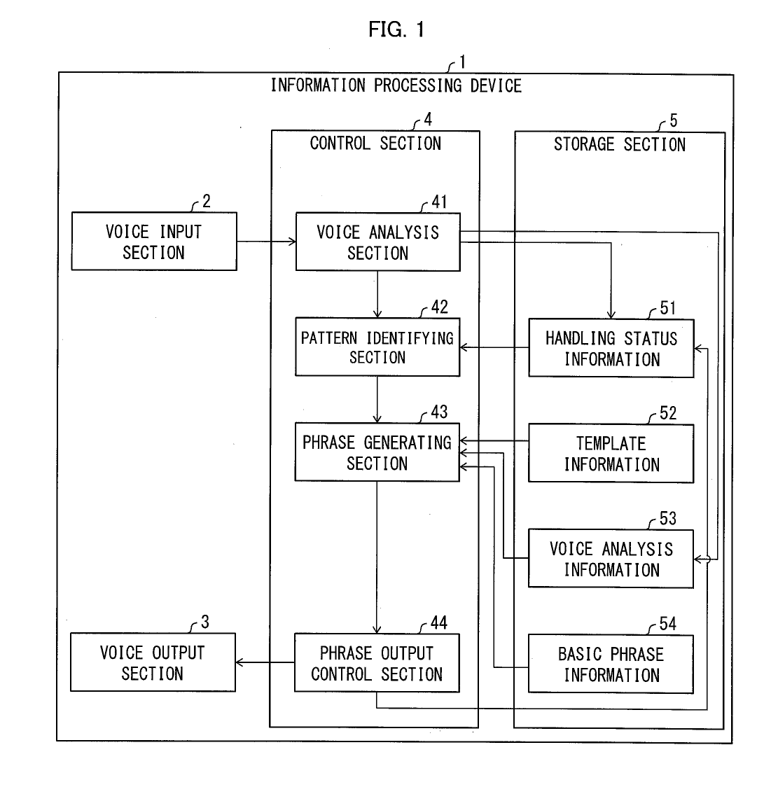

The following description will first discuss a configuration of an information processing device 1 with reference to FIG. 1. FIG. 1 is a function block diagram illustrating a configuration of the information processing device 1. The information processing device 1 is a device which outputs, as a response to one utterance (hereinafter, the utterance is referred to as “processing target utterance (target utterance)”) made by a user by using his/her voice, a phrase which has been generated in accordance with a status of handling carried out by the information processing device 1 with respect to an utterance (hereinafter referred to as “another utterance”) other than the processing target utterance. The information processing device 1 can be a device (e.g., an interactive robot) whose main function is interaction with a user, or a device (e.g., a cleaning robot) having a main function other than interaction with a user. As illustrated in FIG. 1, the information processing device 1 includes a voice input section 2, a voice output section 3, a control section 4, and a storage section 5.

The voice input section 2 converts a voice of a user into a signal and then supplies the signal to the control section 4. The voice input section 2 can be a microphone and/or include an analog/digital (A/D) converter. The voice output section 3 outputs a voice in accordance with a signal supplied from the control section 4. The voice output section 3 can be a speaker and/or include an amplifier circuit and/or a digital/analog (D/A) converter. As illustrated in FIG. 1, the control section 4 includes a voice analysis section 41, a pattern identifying section (handling status identifying section) 42, a phrase generating section (phrase determining section) 43, and a phrase output control section 44.

The voice analysis section 41 analyses the signal supplied from the voice input section 2, and accepts the signal as an utterance. In a case where the voice analysis section 41 accepts the utterance, the voice analysis section 41 (i) stores, as handling status information 51, (a) a number (hereinafter referred to as acceptance number) indicating a position of the utterance in an order in which utterances are accepted and (b) a fact that the utterance has been accepted and (ii) notifies the pattern identifying section 42 of the acceptance number. Further, for each utterance, the voice analysis section 41 stores a result of the analysis of the voice in the storage section 5 as voice analysis information 53.

In a case where the pattern identifying section 42 is notified of the acceptance number by the voice analysis section 41, the pattern identifying section 42 identifies, by referring to the handling status information 51, which of predetermined patterns (handling status patterns) matches a status (hereinafter simply referred to as handling status) of handling carried out by the information processing device 1 with respect to each of a plurality of utterances. More specifically, the pattern identifying section 42 identifies a handling status pattern of handling of another utterance, in accordance with a process (i.e., an acceptance of or a response to the another utterance) which was carried out with respect to the another utterance immediately before a time point (i.e., after the processing target utterance is accepted and before a response to the processing target utterance is outputted) at which the handing status pattern is identified. The pattern identifying section 42 then notifies the phrase generating section 43 of the thus identified handling status pattern, together with the acceptance number. Note that a timing at which the pattern identifying section 42 determines the handling status is not limited to a time point immediately after the pattern identifying section 42 is notified of the acceptance number (i.e., immediately after the processing target utterance is accepted). For example, the pattern identifying section 42 can determine the handling status when a predetermined amount of time passes after the pattern identifying section 42 is notified of the acceptance number.

The phrase generating section 43 generates (determines) a phrase which serves as a response to the utterance, in accordance with the handling status pattern identified by the pattern identifying section 42. A process in which the phrase generating section 43 generates the phrase will be described later in detail. The phrase generating section 43 supplies the thus generated phrase to the phrase output control section 44 together with the acceptance number.

The phrase output control section 44 controls the voice output section 3 to output, as a voice, the phrase supplied from the phrase generating section 43. Further, the phrase output control section 44 controls the storage section 5 to store, as the handling status information 51 together with the acceptance number, a fact that the utterance has been responded.

The storage section 5 stores therein the handling status information 51, template information 52, the voice analysis information 53, and basic phrase information 54. The storage section 5 can be configured by a volatile storage medium and/or a non-volatile storage medium. The handling status information 51 includes information indicative of an order in which utterances are accepted and information indicative of an order in which responses to the respective utterances are outputted. Table 1 below is a table showing examples of the handling status information 51. In Table 1, a “#” column indicates an order in which utterances have been stored, an “acceptance number” column indicates acceptance numbers of the respective utterances, and a “process” column indicates that the information processing device 1 has carried out a process of accepting each of the utterances or a process of outputting a response to each of the utterances.

TABLE 1

| # | Acceptance number | Process |
|---|---|---|
| 1 | N − 1 | Acceptance |
| 2 | N | Acceptance |
| 3 | N + 1 | Acceptance |
| 4 | N | Response |
| 5 | N − 1 | Response |
| 6 | N + 1 | Response |

The template information 52 is information in which a predetermined template to be used by the phrase generating section 43 for generating a phrase serving as a response to an utterance is defined for each handling status pattern. Note that how a handling status pattern is associated with a template will be discussed later in detail with reference to Table 4. The template information 52 in accordance with Embodiment 1 includes templates A through E described below.

The template A is a template in which a phrase (a phrase which is determined in accordance with the basic phrase information 54) serving as a direct answer (response) to an utterance is used as it is as a phrase serving as a response to the utterance. The template A is used in a handling status in which a user can recognize a correspondence relationship between an utterance and a response to the utterance.

The template B is a template in which a phrase serving as a response includes an expression indicating an utterance to which the response is addressed. The template B is used in a handling status in which it is difficult for a user to recognize a correspondence relationship between an utterance and a response to the utterance, for example, in a case where a plurality of utterances are successively made. The expression indicating an utterance to which the response is addressed can be a predetermined expression such as Well, what you were talking about before was or an expression which summarizes the utterance. Specifically, for example, in a case where an utterance is “What's your favorite animal?”, the expression indicating the utterance to which a response is addressed can be “My favorite animal is”, “My favorite is”, “My favorite animal”, or the like. Alternatively, the expression indicating an utterance to which a response is addressed can be an expression in which the utterance is repeated and a fixed phrase is added. Specifically, for example, in a case where the utterance is “What's your favorite animal?”, the expression indicating the utterance to which a response is addressed can be an expression “‘Did you ask me’ (a fixed phrase), ‘What's your favorite animal?’ (repetition of the utterance)”. Alternatively, the expression indicating an utterance to which a response is addressed can be an expression specifying a position of the utterance in an order in which utterances are to be responded, i.e., an expression such as “About the topic you were talking about before the last one”.

The template C is a template for generating a phrase for prompting a user to repeat an utterance. The template C can be, for example, a predetermined phrase such as “What were you talking about before?”, “What did you say before?”, “Please tell me again what you were talking about before”. As with the template B, the template C is also used in the handling status in which it is difficult for a user to recognize a correspondence relationship between an utterance and a response to the utterance. In the case of the template C, a user is prompted to repeat an utterance. Accordingly, for example, in a handling status in which two utterances were successively made and neither of the two utterances has been responded, it is possible to allow the user to select which of the two utterances is to be responded.

The template D is a template for generating a phrase indicating that an utterance which was accepted before a processing target utterance was accepted is being processed, and thus, it is impossible to return a direct response to the processing target utterance. As with the templates B and C, the template D is also used in the handling status in which it is difficult for a user to recognize a correspondence relationship between an utterance and a response to the utterance. With the template D, a user is notified that a first utterance which was accepted before a second utterance (processing target utterance) was accepted is given a higher priority, and a response to the second utterance accepted later is canceled (i.e., an utterance accepted earlier is given a higher priority). This allows a user to recognize a correspondence relationship between an utterance and a response to the utterance. The template D can be, for example, a predetermined phrase such as “I can't answer because I'm thinking about another thing”, “Just a minute”, or “Can you ask that later?”.

The template E is a template for generating a phrase indicating that a process with respect to an utterance which was accepted after the processing target utterance was accepted has been started, and thus, it has become impossible to respond to the processing target utterance. As with the templates B through D, the template E is also used in the handling status in which it is difficult for a user to recognize a correspondence relationship between an utterance and a response to the utterance. With the template E, a user is notified that a first utterance (processing target utterance) which was accepted after a second utterance was accepted is given a higher priority, and a response to the second utterance accepted later is canceled (i.e., an utterance accepted later is given a higher priority). This allows the user to recognize a correspondence relationship between an utterance and a response to the utterance. The template E can be, for example, a predetermined phrase such as “I forgot what I was trying to say” or “You asked me questions one after another, so I forgot what you asked me before.”

The voice analysis information 53 is information indicative of a result of analysis of an utterance made by a user by using a voice. The result of analysis of an utterance made by a user by using a voice is associated with a corresponding acceptance number. The basic phrase information 54 is information for generating a phrase serving as a direct answer to an utterance. Specifically, the basic phrase information 54 is information in which a predetermined utterance expression is associated with (i) a phrase serving as a direct answer to an utterance or (ii) information for generating a phrase serving as a direct answer to an utterance. Table 2 below shows an example of the basic phrase information 54. In a case where the basic phrase information 54 is information shown in Table 2, a phrase (a phrase generated in a case where the template A is used) serving as a direct answer to the utterance “What's your favorite animal?” is “It's dog”. Further, a phrase serving as a direct answer to an utterance “What's the weather today?” is a result which is obtained by inquiring a server (not illustrated) via a communication section (not illustrated). Note that the basic phrase information 54 can be stored in the storage section 5 of the information processing device 1 or in an external storage device which is externally provided to the information processing device 1. Alternatively, the basic phrase information 54 can be stored in the server (not illustrated). The same applies to the other types of information.

TABLE 2

| # | Utterance | Phrase |
|---|---|---|
| 1 | What's your favorite animal? | It's dog. |
| 2 | What's your least favorite | It's cat. |
| | animal? | |
| 3 | What's the weather today? | (obtained by inquiry |
| | | to server) |

### 2. Process Regarding Generation of Response to Utterance

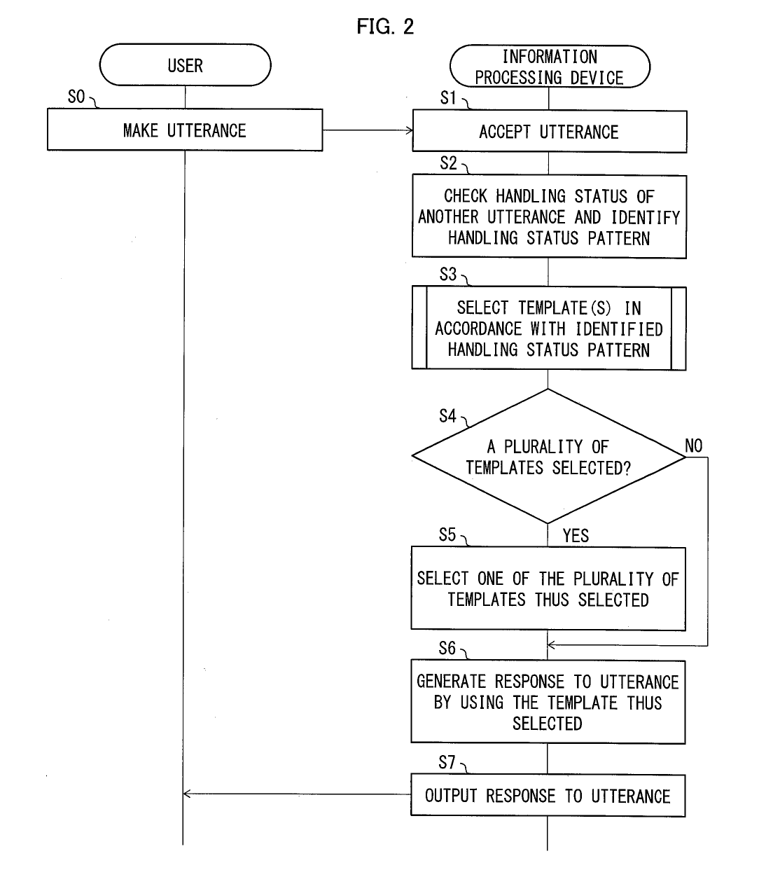

The following description discusses, with reference to FIG. 2, a process in which the information processing device 1 outputs a response to an utterance. FIG. 2 is a flow chart showing a process in which the information processing device 1 outputs a response to an utterance.

First, in a case where a user makes an utterance by using a voice (S0), the voice input section 2 converts an input of the voice into a signal and supplies the signal to the voice analysis section 41. The voice analysis section 41 analyses the signal supplied from the voice input section 2, and accepts the signal as an utterance of the user (S1). In a case where the voice analysis section 41 has accepted the utterance (processing target utterance), the voice analysis section 41 (i) stores, as the handling status information 51, an acceptance number of the processing target utterance and a fact that the processing target utterance has been accepted and (ii) notifies the pattern identifying section of the acceptance number. Further, the voice analysis section 41 stores a result of analysis of the voice of the processing target utterance in the storage section 5 as the voice analysis information 53.

The pattern identifying section 42, which has been notified of the acceptance number by the voice analysis section 41, identifies, by referring to the handling status information 51, which of the predetermined handling status patterns matches a status, immediately before the processing target utterance was accepted, of handling carried out by the information processing device 1 with respect to another utterance (S2). Subsequently, the pattern identifying section 42 notifies the phrase generating section 43 of the thus identified handling status pattern, together with the acceptance number.

The phrase generating section 43, which has been notified of the acceptance number and the handling status pattern by the pattern identifying section 42, selects a single template or a plurality of templates in accordance with the handling status pattern (S3). Subsequently, the pattern identifying section 42 determines whether or not the plurality of templates have been selected instead of the single template (S4). In a case where the plurality of templates have been selected (YES in S4), the phrase generating section 43 selects one of the plurality of templates thus selected (S5). The one of the plurality of templates to be selected can be determined by the phrase generating section 43 in accordance with (i) content of the utterance by referring to the voice analysis information 53 or (ii) other information regarding the information processing device 1.

Next, the phrase generating section 43 generates (determines) a phrase (response) responding to the utterance, by using the one template thus selected (S6). Further, the phrase generating section 43 supplies the thus generated phrase to the phrase output control section 44 together with the acceptance number. Subsequently, the phrase output control section 44 controls the voice output section 3 to output, as a voice, the phrase supplied from the phrase generating section 43 (S7). Further, the phrase output control section 44 controls the storage section 5 to store, as the handling status information 51 together with the acceptance number, a fact that the utterance has been responded.

[2.1. Identification of Handling Status Pattern]

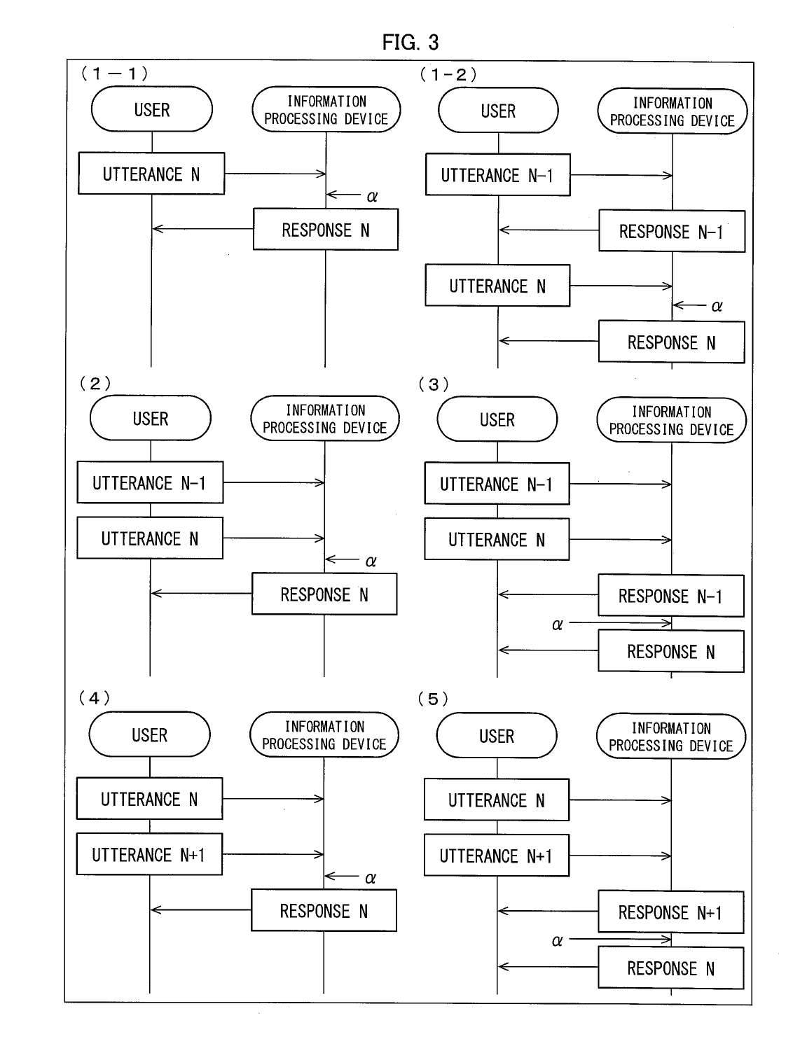

The following description will discuss in detail, with reference to FIG. 3 and Table 3 below, a process (shown in the step S2 in FIG. 2) for identifying a handling status pattern. FIG. 3 is a view showing examples of a handling status of an utterance. Table 3 is a table showing handling status patterns, which are identified by the pattern identifying section 42, of handling of utterances. According to the examples shown in Table 3, a case where another utterance (utterance N+L) is accepted after a processing target utterance is accepted and a case where the processing target utterance is accepted after another utterance (utterance N−M) is accepted are considered as respective different patterns.

TABLE 3

| Name of | Utterance N − M | | Utterance N + M | |
|---|---|---|---|---|
| pattern | Acceptance | Response | Acceptance | Response |
| Pattern 1 | | | — | — |
| Pattern 2 | | x | — | — |
| Pattern 3 | | ∘ | — | — |
| Pattern 4 | — | — | ∘ | x |
| Pattern 5 | — | — | ∘ | ∘ |

Note that N, M, and L each indicate a positive integer. For simplification, the following description will discuss an example in which M=1 and L=1. Symbols “” and “∘” each indicate that at a time point at which the pattern identifying section 42 identifies a handling status pattern of handling of another utterance, a process (an acceptance of or a response to the another utterance) has been carried out. The symbols “” and “∘” differ from each other in that the symbol “” indicates a state in which the process has already been carried out at a time point at which an utterance N is accepted and the symbol “∘” indicates a state in which the process has not been carried out at the time point at which the utterance N is accepted. A symbol “x” indicates a state in which no process has been carried out at the time point at which the pattern identifying section 42 identifies a handling status pattern of handling of another utterance. Note that which of the states indicated by the respective symbols “” and “∘” applies to a predetermined process carried out with respect to another utterance is determined by the pattern identifying section 42 in accordance with a magnitude relationship between (i) a # column value in a row which corresponds to a processing target utterance and indicates “acceptance” and (ii) a # column value in a row which corresponds to another utterance and indicates the predetermined process. An “utterance a” indicates an utterance whose acceptance number is “a”, and a “response a” indicates a response to the “utterance a”. A pattern identified by the pattern identifying section 42 in the process of the step S2 in FIG. 2 is one of patterns 1 through 5 shown in Table 3.

The following description will first discuss how the pattern identifying section 42 identifies a handling status pattern of handling of another utterance in accordance with the handling status information 51. Note that it is assumed that an utterance N indicates a processing target utterance. For example, in regard to the handling status information 51 shown in Table 1, at a time point at which a process shown for #=2, which is “acceptance”, is completed, an acceptance of an utterance N−M (M=1) has been completed but a response to the utterance N−M has not been done. Accordingly, at the above time point, the acceptance of the utterance N-M is indicated by the symbol “” and the response to the utterance N−M is indicated by the symbol “x”. Thus, the pattern identifying section 42 identifies, in accordance with Table 3, that a handling status pattern of handling of the utterance N−M is the pattern 2.

Alternatively, for example, in a case where (i) a subsequent utterance N+L (L=1) is made after the utterance N is accepted and before the utterance N is responded and (ii) the utterance N+L (L=1) is responded before the utterance N, the handling status information 51 is such that a largest # column value corresponds to the utterance N+1 and indicates “response” in the “process” column. Accordingly, the pattern identifying section 42 determines that “acceptance” and “response” for the utterance N+L are each indicated by the symbol “”. Thus, in this case, the pattern identifying section determines that a handling status pattern of handling of the utterance N+L is the pattern 5.

The following description will discuss, with reference to FIG. 3, an example case where (i) the utterance N is accepted in the process of the step S1 in FIG. 2 and (ii) a handling status pattern of handling of another utterance is determined at a time point indicated by α shown in FIG. 3. Note that a handling status pattern of handling of another utterance only needs to be identified during a period (a period during which a response to the utterance N is generated) after the utterance N is accepted and before the utterance N is responded, and a timing at which the pattern is identified is not limited to the time point indicated by α shown in FIG. 3.

At a time point indicated by α shown in (1-2) of FIG. 3, an utterance which was made immediately before the utterance N is an utterance N−1 (i.e., an acceptance process with respect to the utterance N−M is indicated by the symbol “”). Further, at a time point at which the utterance N is accepted, a response N−1 to the utterance N−1 has been outputted (i.e., a response process with respect to the utterance N−M is indicated by the symbol “”). Accordingly, the pattern identifying section 42 identifies, in accordance with Table 3, that a handling status pattern of handling of the utterance N−1 at the time point indicated by α shown in (1-2) of FIG. 3 is the pattern 1.

At a time point indicated by α shown in (2) of FIG. 3, an utterance which was made immediately before the utterance N is an utterance N−1 (i.e., an acceptance process with respect to the utterance N−M is indicated by the symbol “”). Further, no response to the utterance N−1 has been outputted (i.e., a response process with respect to the utterance N−M is indicated by the symbol “x”). Accordingly, the pattern identifying section 42 identifies, in accordance with Table 3, that a handling status pattern of handling of the utterance N−1 at the time point indicated by α shown in (2) of FIG. 3 is the pattern 2.

Similarly, the pattern identifying section 42 identifies that handling status patterns of handling of respective another utterances at time points indicated by α shown in (3), (4), and (S) of FIG. 3 are the patterns 3, 4, and 5, respectively. In (1-1) of FIG. 3, no utterance is made immediately before the utterance N at a time point indicated by α. According to Embodiment 1, the pattern identifying section 42 identifies the pattern 1 as a handling status pattern corresponding to such a case where no utterance is made immediately before the utterance N.

[2.2. Selection of Template in Accordance with Handling Status Pattern]

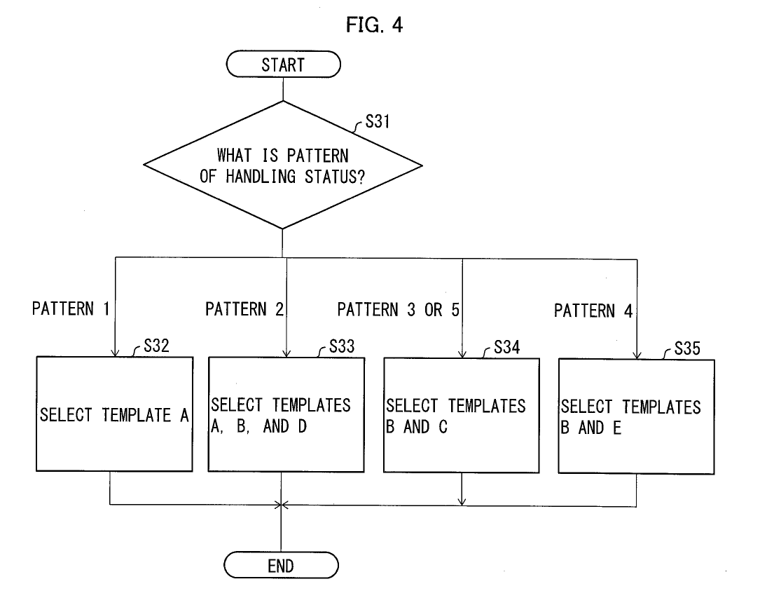

The following description will discuss in detail, with reference to FIG. 4 and Table 4 below, the process (shown in the step S3 in FIG. 2) of selecting a template in accordance with an identified handling status pattern. FIG. 4 is a flow chart showing details of the process of the step S3 in FIG. 2. Table 4 is a table showing a correspondence relationship between handling status patterns and templates to be selected.

TABLE 4

| | Template | Template | Template | Template | Template |
|---|---|---|---|---|---|
| | A | B | C | D | E |
| Pattern 1 | ∘ | x | x | x | x |
| Pattern 2 | ∘ | ∘ | x | ∘ | x |
| Pattern 3 | x | ∘ | ∘ | x | x |
| Pattern 4 | x | ∘ | x | x | ∘ |
| Pattern 5 | x | ∘ | ∘ | x | x |

The phrase generating section 43 checks a handling status pattern which has been notified by the pattern identifying section 42 (S31). Subsequently, the phrase generating section 43 selects a template corresponding to the handling status pattern notified by the pattern identifying section 42 (S32 through S35). The template selected is any one(s) of the templates indicated with a symbol “∘” in Table 4. For example, in a case where the handling status pattern notified by the pattern identifying section 42 is the pattern 1, the template A is selected (S32).

With the configuration, in a case where it is clear to which utterance a response is addressed (i.e., in a case of a pattern 1-1 or 1-2), a template for generating a simple phrase serving as a direct answer to the utterance is used. Meanwhile, in a case where it is not necessarily clear to which utterance a response is addressed (i.e., in a case of each of the patterns 2 through 5), a template (one of the templates B through E) which takes account of a handling status of another utterance is used.

### Modified Example

In Embodiment 1, in a case where the handling status identified in the process of the step S2 in FIG. 2 is one of the patterns 2 through 5 (i.e., a second handling status), the phrase generating section 43 can select a template (template B) in which a phrase serving as a response includes an expression indicating an utterance to which the response is addressed.

With the configuration, in a case where a plurality of utterances are successively made, it is possible to return a response in which it is clear to which of the plurality of utterances the response is addressed. This allows a user to recognize the utterance to which the response corresponds. In a case where the handling status is the pattern 1 (i.e., a first handling status), the template B is not used (the template A is used). Accordingly, in a case where an utterance to which a response is addressed is clear (i.e., in a case of the pattern 1), it is possible to output a simpler phrase as the response, as compared with a case where the template B is always used.

In a case of a handling status in which a plurality of utterances have been accepted but not responded (e.g., the patterns 2 and 4), the phrase generating section 43 can select a template, such as the template D or E, for generating a phrase indicating that an utterance to be responded has been selected from the plurality of utterances. In this case, it is possible to cancel a process (e.g., a voice analysis) to be carried out with respect to an utterance (an utterance for which a response has been cancelled) which has not been selected. Further, in a case where a load of a process carried out by the information processing device 1 exceeds a predetermined threshold, it is possible to cancel a process (e.g., voice analysis) to be carried out with respect to at least one of the plurality of utterances which have not been responded. In this case, the phrase generating section 43 can select a template in accordance with an utterance for which a process has not been cancelled. In a case where the phrase generating section 43 uses a template, such as the template D or E, by which a response can be generated without analyzing content of an utterance, it is possible to immediately return a response. Accordingly, the above configuration makes it possible to more smoothly communicate with a user.

The phrase generating section 43 can select the template B in a case where the phrase generating section 43 has considered whether or not it is difficult for a user to recognize an utterance to which a response is addressed and then determined that the recognition is difficult. It is not particularly limited how the phrase generating section 43 makes the determination. For example, the phrase generating section 43 can make the determination in accordance with a word and/or a phrase included in an utterance or a response (a response phrase stored in the basic phrase information 54) to the utterance. For example, in a case where utterances “What's your least favorite animal?” and “What's your favorite animal?” are made, the template B can be selected. This is because the above utterances are similar to each other in that both the utterances include a word “animal”, so that responses to the respective utterances may be similar to each other.

Since Embodiment 1 has discussed an example case in which the number of utterances other than the processing target utterance is one (i.e., another utterance), only one handling status pattern has been identified with respect to the another utterance. Note, however, that in a case where there are a plurality of other utterances, it is possible to identify a handling status pattern with respect to each of the plurality of other utterances. In this case, a plurality of different patterns may be identified. In a case where a plurality of patterns have been identified, it is possible to select a template which corresponds to all of the plurality of different patterns thus identified. For example, in a case where the patterns 2 and 4 have been identified, the phrase generating section 43 selects the template B for which the symbol “∘” is shown in each of the “pattern 2” row and the “pattern 4” row in Table 4. In a case where a plurality of patterns other than the pattern 1 have been identified as handling status patterns, the template E can be selected.

Embodiment 1 has discussed an example in which the information processing device 1 directly receives an utterance of a user. Note, however, that a function similar to that of Embodiment 1 can be also achieved by an interactive system in which the information processing device 1 and a device which accepts an utterance of a user are separately provided. The interactive system can include, for example, (i) a voice interactive device which accepts an utterance of a user and outputs a voice responding to the utterance and (ii) an information processing device which controls the voice outputted from the voice interactive device. The interactive system can be configured such that (i) the voice interactive device notifies the information processing device of information indicative of content of the utterance of the user and (ii) the information processing device carries out, in accordance with the notification from the voice interactive device, a process similar to the process carried out by the information processing device 1. Note that, in this case, the information processing device only needs to have at least a function of determining a phrase to be outputted by the voice interactive device, and the phrase can be generated by the information processing device or the voice interactive device.

### Embodiment 2

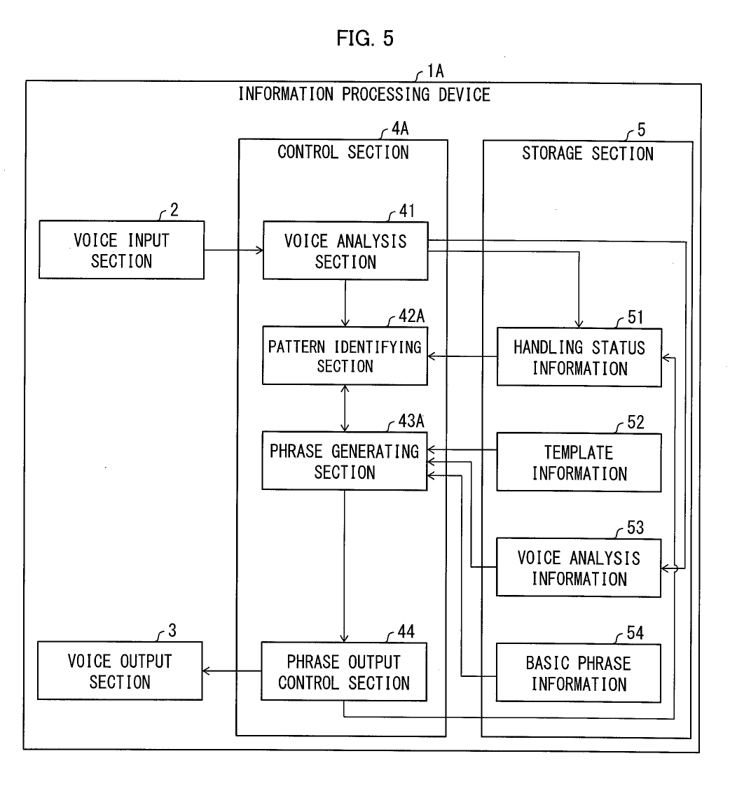

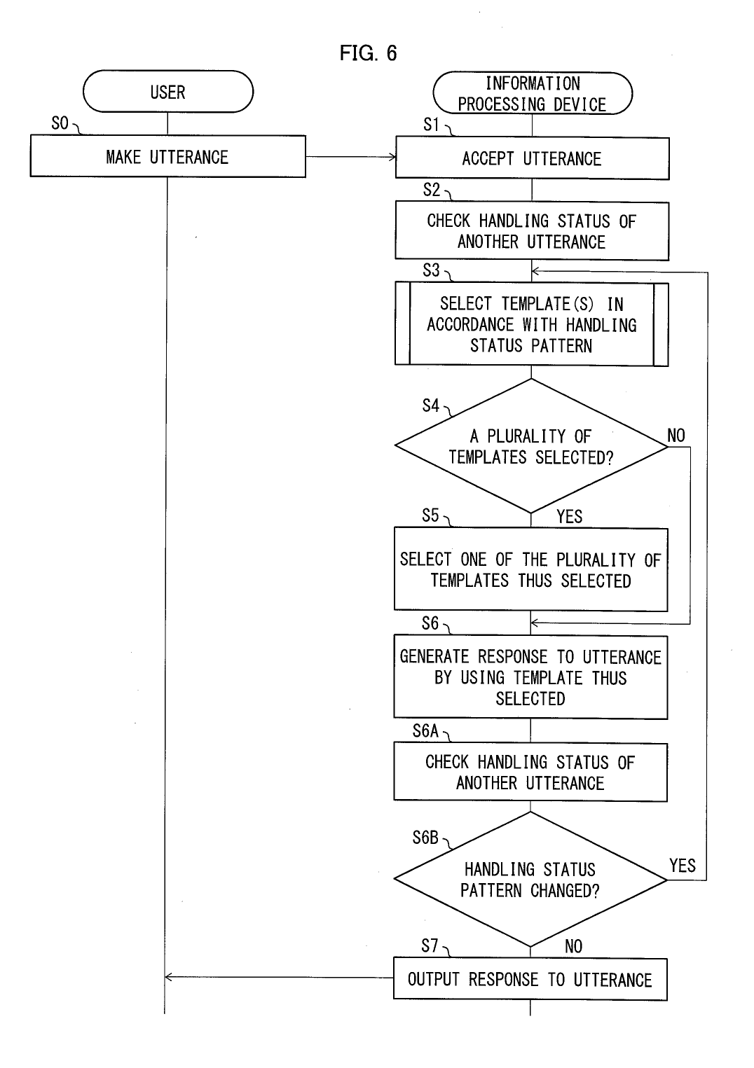

The following description will discuss another embodiment of the present invention with reference to FIGS. 5 and 6. For easy explanation, the same reference signs will be given to members or processes each having the same function as a member or a process of Embodiment 1 and descriptions on such a member or a process will be omitted. First, a difference between an information processing device 1A in accordance with Embodiment 2 and the information processing device 1 in accordance with Embodiment 1 will be discussed below with reference to FIG. 5. FIG. 5 is a function block diagram illustrating a configuration of the information processing device 1A in accordance with Embodiment 2.

The information processing device 1A in accordance with Embodiment 2 differs from the information processing device 1 in accordance with Embodiment 1 in that the information processing device 1A includes a control section 4A instead of the control section 4. The control section 4A differs from the control section 4 in that the control section 4A includes a pattern identifying section 42A and a phrase generating section 43A, instead of the pattern identifying section 42 and the phrase generating section 43.

The pattern identifying section 42A differs from the pattern identifying section 42 in that the pattern identifying section 42A (i) is notified by the phrase generating section 43A that a phrase serving as a response to a processing target utterance has been generated and then (ii) reidentifies which of the handling status patterns matches a handling status of another utterance. The pattern identifying section 42A re-notifies the phrase generating section 43A of the thus identified handling status pattern, together with an acceptance number.

The phrase generating section 43A differs from the phrase generating section 43 in that in a case where the phrase generating section 43A generates a phrase serving as a response to the processing target utterance, the phrase generating section 43A notifies the pattern identifying section 42A that the phrase has been generated. The phrase generating section 43A differs from the phrase generating section 43 also in that in a case where the phrase generating section 43A is notified of a handling status pattern from the pattern identifying section 42A together with an acceptance number identical to an acceptance number previously notified, the phrase generating section 43A determines whether or not the handling status pattern has changed, and in a case where the handling status pattern has changed, the phrase generating section 43A generates a phrase in accordance with the handling status pattern thus changed.

The following description will discuss, with reference to FIG. 6, a process in which the information processing device 1A outputs a response to an utterance. FIG. 6 is a flow chart showing a process in which the information processing device 1A outputs a response to an utterance.

In a process of the step S6 in FIG. 6, the phrase generating section 43A which has generated a phrase serving as a response to a processing target utterance notifies the pattern identifying section 42A that the phrase has been generated. Upon reception of the notification from the phrase generating section 43A, the pattern identifying section 42A checks a handling status of another utterance (S6A) and notifies the phrase generating section 43A of the handling status, together with an acceptance number.

The phrase generating section 43A, which has been re-notified of the handling status, determines whether or not a handling status pattern has changed (S6B). In a case where the handling status pattern has changed (YES in S6B), the phrase generating section 43A repeats processes of the step S3 and subsequent steps. That is, the phrase generating section 43A generates again a phrase serving as a response to the processing target utterance. Meanwhile, in a case where the handling status pattern has not changed (NO in S6B), the process of the step S7 is carried out, so that the phrase generated in the process of the step S6 is outputted as a response to the processing target utterance.

With the configuration, even in a case where a handling status of another utterance changes while a phrase responding to an utterance is being generated, it is possible to output an appropriate phrase. Note that a timing at which the phrase generating section 43A rechecks the handling status is not limited to the above example (i.e., at a time point at which the generation of the phrase is completed). The phrase generating section 43A can recheck the handling status at any time point at which the handling status may have changed during a period after the handling status is checked for the first time and before a response is outputted to the processing target utterance. For example, the phrase generating section 43A can recheck the handling status when a predetermined time passes after the handling status was checked for the first time.

### Embodiment 3

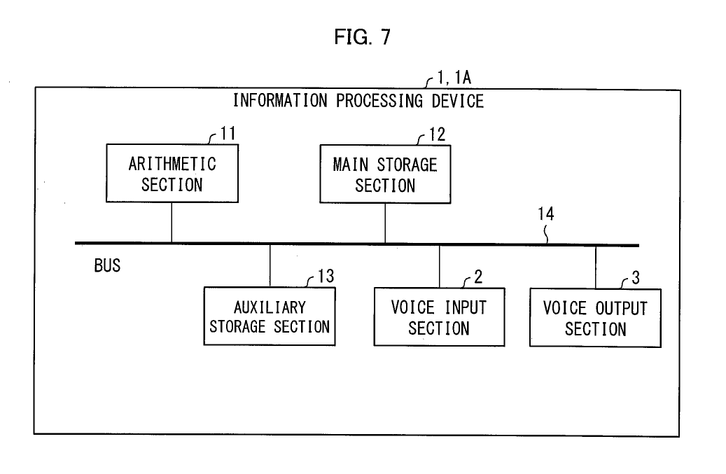

Each block of the information processing devices 1 and 1A can be realized by a logic circuit (hardware) provided in an integrated circuit (IC chip) or the like or can be alternatively realized by software as executed by a central processing unit (CPU). In the latter case, the information processing devices 1 and 1A can be each configured by a computer (electronic calculator) as illustrated in FIG. 7. FIG. 7 is a block diagram illustrating, as an example, a configuration of a computer usable as each of the information processing devices 1 and 1A.

In this case, as illustrated in FIG. 7, the information processing devices 1 and 1A each include an arithmetic section 11, a main storage section 12, an auxiliary storage section 13, a voice input section 2, and a voice output section 3 which are connected with each other via a bus 14. The arithmetic section 11, the main storage section 12, and the auxiliary storage section 13 can be, for example, a CPU, a random access memory (RAM), and a hard disk drive, respectively. Note that the main storage section 12 only needs to be a computer-readable “non-transitory tangible medium”, and examples of the main storage section 12 encompass “a non-transitory tangible medium” such as a tape, a disk, a card, a semiconductor memory, and a programmable logic circuit.

The auxiliary storage section 13 stores therein various programs for causing a computer to operate as each of the information processing devices 1 and 1A. The arithmetic section 11 causes the computer to function as sections included in each of the information processing devices 1 and 1A by loading, on the main storage section 12, the programs stored in the auxiliary storage section 13 and executing instructions included in the programs thus loaded on the main storage section 12.

The above description has discussed the configuration in which a computer is caused to function as each of the information processing devices 1 and 1A by using the programs stored in the auxiliary storage section 13 which is an internal storage medium. Note, however, that it is possible to use a program stored in an external storage medium. The program can be made available to the computer via any transmission medium (such as a communication network or a broadcast wave) which allows the program to be transmitted. Note that the present invention can also be implemented by the program in the form of a computer data signal embedded in a carrier wave which is embodied by electronic transmission.

[Main Points]

An information processing device (1, 1A) in accordance with a first aspect of the present invention is an information processing device that determines a phrase responding to a voice which a user has uttered to the information processing device, including: a handling status identifying section (pattern identifying section 42, 42A) for, in a case where a target utterance with respect to which a phrase is to be determined as a response is accepted, identifying a status of handling carried out by the information processing device with respect to another utterance which differs from the target utterance; and a phrase determining section (phrase generating section 43) for determining, as a phrase responding to the target utterance, a phrase in accordance with the handling status identified by the handling status identifying section.

With the configuration, in response to an utterance made by a user, a phrase is outputted in accordance with a handling status of another utterance. Note that the another utterance is an utterance(s) to be considered for determining a phrase responding to the target utterance. For example, the another utterance can be (i) an M utterance(s) accepted immediately before the target utterance, (ii) an L utterance(s) accepted immediately after the target utterance, or (iii) both of the M utterance(s) and the L utterance(s) (L and M are each a positive number). In a case where there are a plurality of other utterances, the handling status of the another utterance can be a handling status of one of the plurality of other utterances or a handling status which is identified by comprehensively considering handling statuses with respect to the respective plurality of other utterances. This makes it possible to output a more appropriate phrase with respect to a plurality of utterances, as compared with a configuration in which a fixed phrase is outputted with respect to an utterance irrespective of a handling status of another utterance. Note that the handling status identifying section determines a handling status at a time point after an utterance is accepted and before a phrase is outputted in accordance with the utterance. The phrase determined by the information processing device can be outputted by the information processing device. Alternatively, it is possible to cause another device to output the phrase.

In a second aspect of the present invention, an information processing device can be configured such that, in the first aspect of the present invention, the handling status identifying section identifies, as respective different handling statuses, a case where the another utterance is accepted after the target utterance is accepted and a case where the target utterance is accepted after the another utterance is accepted. The configuration makes it possible to determine an appropriate phrase in accordance with each of (i) the case where the another utterance is accepted after the target utterance is accepted and (ii) the case where the target utterance is accepted after the another utterance is accepted. For example, in a case where two utterances are successively made, it is also possible to output a phrase appropriate to each of the following handling statuses: (1) a handling status in which only one of the two utterances, which one was accepted earlier than the other one, has been responded; and (2) a handling status in which only the other one of the two utterances, which other one was accepted later, has been responded.

In a third aspect of the present invention, an information processing device can be configured such that, in the first or second aspect of the present invention, the handling status includes: a first handling status in which the target utterance is accepted in a state in which a phrase responding to the another utterance has been determined; and a second handling status in which the target utterance is accepted in a state in which a phrase responding to the another utterance has not been determined; and in a case where the handling status identified by the handling status identifying section is the second handling status, the phrase determining section determines a phrase in which a phrase which is determined in the first handling status is combined with a phrase indicating the target utterance. With the configuration, in the second handling status in which it is difficult for a user to recognize a correspondence relationship between an utterance and a response to the utterance, the phrase determining section determines a phrase in which a phrase determined in the first handling status, in which a correspondence relationship between an utterance and a response to the utterance is clear to a user, is combined with a phrase indicating a target utterance. This allows the user to recognize an outputted phrase is a response to the target utterance.

In a fourth aspect of the present invention, an information processing device can be configured such that, in the first through third aspects of the present invention, after the handling status identifying section identifies the handling status to be a certain handling status, the handling status identifying section reidentifies the handling status to be another handling status at a time point at which there is a possibility that the handling status changes from the certain handling status to a different handling status; and in a case where the certain handling status, which the handling status identifying section has identified earlier, differs from the another handling status, which the handling status identifying section has identified later, the phrase determining section (phrase generating section 43A) determines a phrase in accordance with the another handling status. With the configuration, even in a case where a handling status of another phrase changes while a phrase responding to an utterance is being generated, it is possible to output an appropriate phrase.

The information processing device in accordance with the foregoing aspects of the present invention may be realized by a computer. In this case, the present invention encompasses: a control program for the information processing device which program causes a computer to operate as each section (software element) of the information processing device so that the information processing device can be each realized by the computer; and a computer-readable storage medium storing the control program therein.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to an information processing device and an information processing system each for outputting a predetermined phrase to a user in accordance with a voice uttered by the user.

### REFERENCE SIGNS LIST

1, 1A: Information processing device
42, 42A: Pattern identifying section (handling status identifying section)
43, 43A: Phrase generating section (phrase determining section)

1. An information processing device that determines a phrase responding to a voice which a user has uttered to the information processing device, comprising:
a handling status identifying section for, in a case where a target utterance with respect to which a phrase is to be determined as a response is accepted, identifying a handling status of another utterance which differs from the target utterance; and
a phrase determining section for determining, as a phrase responding to the target utterance, a phrase in accordance with the handling status identified by the handling status identifying section.

2. The information processing device as set forth in claim 1, wherein the handling status identifying section identifies, as respective different handling statuses, a case where the another utterance is accepted after the target utterance is accepted and a case where the target utterance is accepted after the another utterance is accepted.

3. The information processing device as set forth in claim 1, wherein:
the handling status includes:
a first handling status in which the target utterance is accepted in a state in which a phrase responding to the another utterance has been determined; and
a second handling status in which the target utterance is accepted in a state in which a phrase responding to the another utterance has not been determined; and
in a case where the handling status identified by the handling status identifying section is the second handling status, the phrase determining section determines a phrase in which a phrase which is determined in the first handling status is combined with a phrase indicating the target utterance.

4. The information processing device as set forth in claim 1, wherein
after the handling status identifying section identifies the handling status to be a certain handling status, the handling status identifying section reidentifies the handling status to be another handling status at a time point at which there is a possibility that the handling status changes from the certain handling status to a different handling status; and
in a case where the certain handling status, which the handling status identifying section has identified earlier, differs from the another handling status, which the handling status identifying section has identified later, the phrase determining section determines a phrase in accordance with the another handling status.

5. (canceled)
